(19) United States
(12) Patent Application Publication
(10) Pub. No.: US 2010/0087284 A1
(43) Pub. Date: Apr. 8, 2010

(54) AUTO-TENSIONER

(76) Inventor: Takayuki Norimatsu, Iwata (JP)

Correspondence Address: WENDEROTH, LIND & PONACK, L.L.P., 1030 15th Street, N.W.,, Suite 400 East, Washington, DC, 20005-1503, US

(21) Appl. No.: 12/564,186

(22) Filed: Sep. 22, 2009

(30) Foreign Application Priority Data
Oct. 7, 2008 (JP) 2008-260663

(51) Int. Cl. F16H 7/08

(52) U.S. Cl. 474/110

(57) ABSTRACT

An auto-tensioner includes a cylinder, and a sleeve having a bottom and fitted in the cylinder. Hydraulic oil is stored in the cylinder. A plunger is slidably inserted in the sleeve, thereby partitioning the interior of the housing into a pressure chamber and a reservoir chamber. The pressure chamber communicates with the reservoir chamber through an oil passage. A check valve is provided at the oil passage that permits only the flow of hydraulic oil from the reservoir chamber into the pressure chamber through the oil passage. The check valve includes a ceramic ball configured to move into contact with and separate from a seating surface formed on the end of the oil passage facing the pressure chamber, and a retainer for restricting the moving range of the ceramic material. The ceramic ball has a surface roughness Ra of not more than 0.01.

### BACKGROUND OF THE INVENTION

This invention relates to an auto-tensioner used to keep the tension of a belt or a chain for driving engine camshafts, or a belt or a chain for driving automotive engine accessories such as an alternator.

In a typical automotive engine, the rotation of the crankshaft is transmitted to camshafts through a belt or a chain to rotate the camshafts, thereby opening and closing valves of the combustion chambers. Automotive engine accessories, such as an alternator, an air-conditioner and a water pump, are also coupled to the engine crankshaft through a belt or a chain (description is hereinafter made only referring to a belt as a non-limiting example), and are driven by the engine through the belt. In order to keep the tension of the belt within an optimum range, a tension adjusting device is used which comprises a pulley arm pivotable about a pivot shaft, a tension pulley rotatably mounted on the pulley arm, and an auto-tensioner biasing the pulley arm to press the tension pulley against the belt.

Known auto-tensioners for such a tension adjusting device includes one disclosed in JP Patent Publication 2003-301901A, which includes a cylinder having a bottom at its lower end, and a sleeve having a bottom and fitted in the cylinder. Hydraulic oil is stored in the cylinder. A plunger is slidably inserted in the sleeve, thereby partitioning the interior of the cylinder into a pressure chamber and a reservoir chamber. This auto-tensioner further includes a rod that is axially movable together with the plunger, and a return spring biasing the rod in such a direction that the volume of the pressure chamber increases.

In this auto-tensioner, the rod is configured to move until the biasing force of the return spring is balanced with the tension of the belt, thereby minimizing fluctuations in tension of the belt.

The pressure chamber and the reservoir chamber are in communication with each other through a leakage gap defined between sliding surfaces of the sleeve and the plunger. When the rod moves in a direction to reduce the volume of the pressure chamber, hydraulic oil in the pressure chamber leaks through the leakage gap. At this time, since the flow rate of hydraulic oil that flows through the leakage gap is restricted, the rod moves slowly.

The pressure chamber and the reservoir chamber are also in communication with each other through an oil passage provided with a check valve that permits only the flow of hydraulic oil from the reservoir chamber into the pressure chamber. When the rod moves in the direction to increase the volume of the pressure chamber, the check valve opens and hydraulic oil flows from the reservoir chamber into the pressure chamber through the oil passage. Thus, the rod can move quickly in the direction to increase the volume of the pressure chamber.

In this auto-tensioner, the check valve that permits only the flow of hydraulic oil from the reservoir chamber into the pressure chamber comprises a ball for opening and closing the oil passage by moving into contact with and separating from a seating surface formed on the end of the oil passage facing the pressure chamber, and a retainer for restricting the moving range of the ball.

The end of the oil passage facing the pressure chamber is open to the top surface of the bottom of the sleeve, and this top opening is opened and closed by the ball of the check valve. In order to minimize wear of the ball and the seating surface of the check valve, the ball of the check valve is made of a ceramic material.

But even though the ball is made of a ceramic material, it was difficult to sufficiently reduce the wear of the seating surface after long-term use. When the seating surface of the check valve becomes worn excessively, the ball tends to come into close contact with and become less easily separable from the seating surface. This may make the check valve inoperative.

An object of the present invention is to provide an auto-tensioner of which the seating surface of the check valve is less likely to become worn.

### SUMMARY OF THE INVENTION

The inventor of the present invention conducted an endurance test for an auto-tensioner including a check valve comprising a ceramic ball configured to be brought into contact with and separate from a seating surface formed at the end of the oil passage facing the pressure chamber, and a retainer for restricting the moving range of the ceramic ball, with the surface roughness of the ceramic ball varied. As a result, it has been discovered that by setting the surface roughness value Ra to not more than 0.01, the seating surface of the check valve is extremely less likely to get worn, compared to when the surface roughness value Ra of the ceramic ball is larger than 0.01.

In this auto-tensioner, the end of the oil passage facing the pressure chamber preferably opens to the bottom surface of the plunger, with the bottom opening of the oil passage opened and closed by the ceramic ball. With this arrangement, because hydraulic oil flows downward when the check valve opens, wear dust is less likely to stay between the ceramic ball and the seating surface, thus reducing the possibility of wear due to wear dust.

The ceramic ball may be made of silicon nitride, while the seating surface may be made of iron.

Since the auto-tensioner according to the present invention includes a ceramic ball having a surface roughness value Ra of not more than 0.01, the seating surface of the check valve is extremely less likely to get worn. Thus, the check valve shows improved durability.

### BRIEF DESCRIPTION OF THE DRAWINGS

FIG. 1 is a sectional view of a tension adjusting device including an auto-tensioner embodying this invention;

FIG. 2 is an enlarged partial sectional view of the auto-tensioner of FIG. 1, showing its check valve; and

FIG. 3 is a graph showing the degree of wear of the seating surface of the check valve in each of many auto-tensioner samples of which the respective check balls have different surface roughness values from each other.

### DETAILED DESCRIPTION OF THE PREFERRED EMBODIMENTS

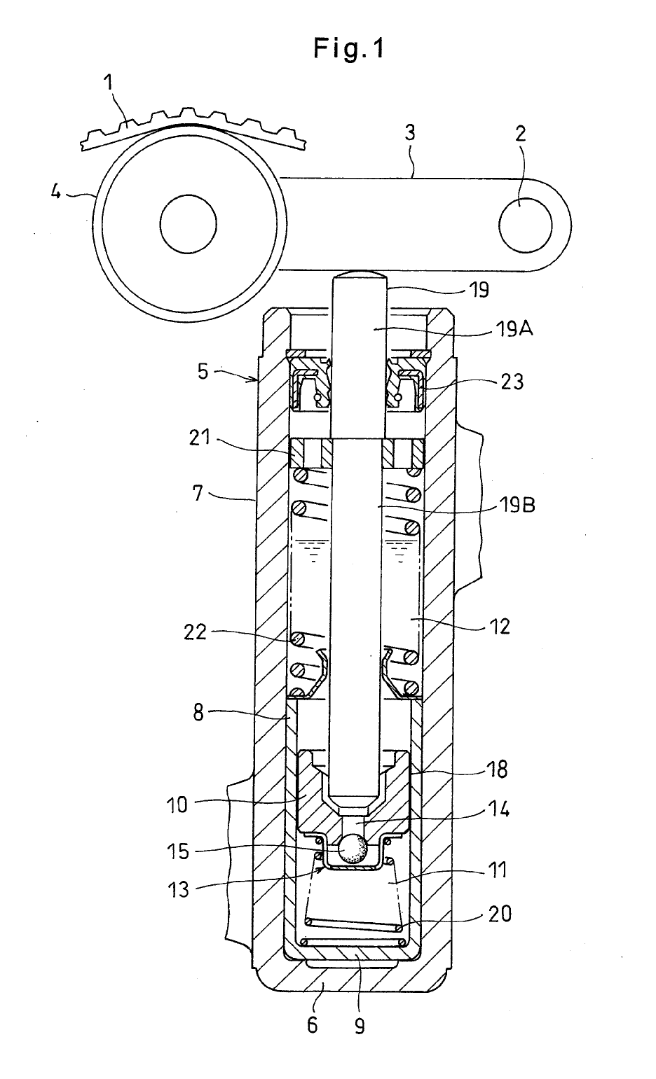

FIG. 1 shows a tension adjusting device for a belt 1 for driving engine camshafts. This tension adjusting device comprises a pulley arm 3 pivotable about a pivot shaft 2, a tension pulley 4 rotatably mounted on the pulley arm 3, and an auto-tensioner 5 embodying the present invention. The auto-tensioner 5 biases the pulley arm 3 to press the tension pulley 4 against the belt 4.

The auto-tensioner 5 includes a cylinder 7 having a bottom 6 at its lower end. Hydraulic oil is stored in the cylinder 7. A sleeve 8 having a bottom 9 is inserted in the cylinder 7 with the bottom 9 located downward. The outer periphery of the sleeve 8 is fitted in the inner periphery of the cylinder 7. A plunger 10 is axially slidably inserted in the sleeve 8. The sleeve 8 and the plunger 10 partition the interior of the cylinder 7 into a pressure chamber 11 and a reservoir chamber 12.

The pressure chamber 11 and the reservoir chamber 12 communicate with each other through an oil passage 14 where a check valve 13 that permits only the flow of hydraulic oil from the reservoir chamber 12 into the pressure chamber 11. The oil passage 14 extends through the plunger 10 from its top to bottom surface. Thus, the oil passage 14 has its bottom end open to the bottom surface of the plunger 10 and to the pressure chamber 11. A ceramic ball 15 of the check valve 13 is configured to selectively open and close this bottom opening of the oil passage 14.

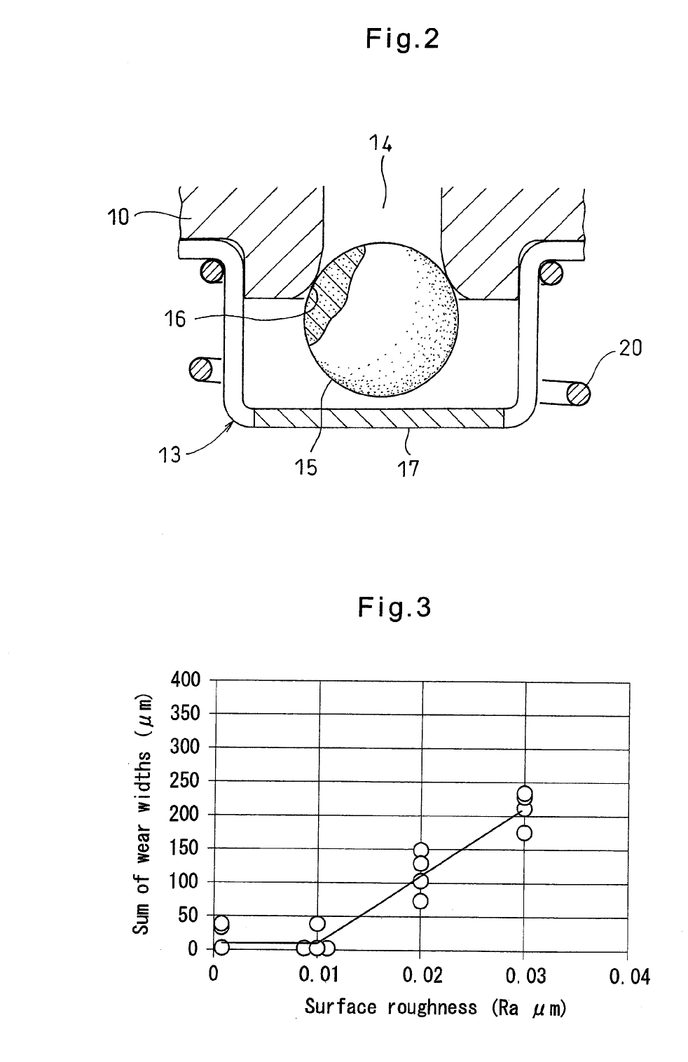

As shown in FIG. 2, the check valve 13 comprises the ceramic ball 15, which is configured to selectively open and close the oil passage 14 by moving into contact with and separating from a seating surface 16 formed on the end of the oil passage 14 facing the pressure chamber 11, and a retainer 17 for restricting the moving range of the ceramic ball 15. The ceramic ball 15 is made of silicone nitride (Si₃N₄), and is subjected to lapping to the surface roughness Ra of not more than 0.01. The seating surface 16 is an annular surface having a chamfer with a predetermined radius of curvature formed along the edge of the bottom opening of the oil passage 14. The seating surface 16 is made of iron.

Between the sliding surfaces of the sleeve 8 and the plunger 10, a leakage gap 18 is defined through which the pressure chamber 11 communicates with the reservoir chamber 12.

A rod 19 is connected to the plunger 10 so as to extend upwardly from the plunger 10 and protrude from the cylinder 7. The plunger 10 is biased by a plunger spring 20 mounted in the pressure chamber 11 and pressed against the rod 19. Thus, the rod 19 and the plunger 10 never separate from each other when they move axially.

The rod 19 comprises a large-diameter shaft portion 19A and a small-diameter shaft portion 19B extending downwardly from the bottom end of the large-diameter portion 19A. A wear ring 21 is fitted around the small-diameter shaft portion 19B so as to be axially slidable on the inner periphery of the cylinder 7. The wear ring 21 supports the bottom end of the large-diameter shaft portion 19A.

A return spring 22 is mounted in the cylinder 7. The return spring 22 has its bottom end supported by the sleeve 8 and presses the wear ring 21 upwardly with its top end, thus biasing the rod 19 through the wear ring 21 in such a direction that the volume of the pressure chamber 11 increases.

An oil seal 23 is fitted on the inner periphery of the cylinder 7 at its top end portion to prevent leakage of hydraulic oil in the cylinder 7. The oil seal 23 is an annular member with the large-diameter shaft portion 19A of the rod 19 slidably extending therethrough.

The operation of this auto-tensioner 5 is now described.

When the tension of the belt 1 increases, the tension is transmitted through the tension pulley 4 and the pulley arm 3 to the rod 19, thereby increasing the pressure in the pressure chamber 11. When the pressure in the pressure chamber 11 becomes higher than the pressure in the reservoir chamber 12, hydraulic oil flows from the pressure chamber 11 into the reservoir chamber 12 through the leakage gap 18. In this state, since the oil passage 14 is closed by the check valve 13, hydraulic oil never flows through the oil passage 14.

When hydraulic oil flows through the leakage gap 18, the rod 19 moves downwardly together with the tension pulley 4 until the tension of the belt 1 is balanced with the biasing force of the return spring 22. Because the flow rate of hydraulic oil through the leakage gap 18 is restricted, the tension pulley 4 moves slowly due to the damper effect. Thus, it is possible to stabilize the behavior of the belt 1.

When the tension of the belt 1 decreases, under the force of the return spring 22, the rod 19 moves upward. At this time, since the volume of the pressure chamber 11 increases, the pressure in the pressure chamber 11 decreases. When the pressure in the pressure chamber 11 becomes lower than the pressure in the reservoir chamber 12, the check valve 13 opens and hydraulic oil flows from the reservoir chamber 12 into the pressure chamber 11 through the oil passage 14. The tension pulley 4 thus quickly moves until the tension of the belt 1 is balanced with the biasing force of the return spring 22, thereby quickly eliminating slackness of the belt 1.

Because the ceramic ball 15 used in this auto-tensioner has a surface roughness Ra of not more than 0.01, the seating surface 16 of the check valve 13 is extremely less likely to get worn by the ceramic ball 15. This ensures durability of the check valve 13.

In this auto-tensioner 5, since the end of the oil passage 14 facing the pressure chamber 11 opens to the bottom surface of the plunger 10, when the check valve 13 opens, hydraulic oil flows downward. Thus, wear dust is less likely to stay between the ceramic ball 15 and the seating surface 16. This minimizes the wear of these parts due to wear dust.

Further, because this auto-tensioner 5 has no valve spring for pressing the ceramic ball 15 against the seating surface 16, the surface pressure applied to the seating surface 16 from the ceramic ball 15 is low. This further slows down the wear of the seating surface 16.

### EXAMPLE 1

In order to determine how effectively the wear of the seating surface 16 decreases when the surface roughness Ra of the ceramic ball 15 is reduced to not more than 0.01, a large number of auto-tensioner samples were prepared including ceramic balls 15 having different surface roughness values from each other, and subjected to a test in which loads were repeatedly applied to the rods 19 of the respective samples from a vibrator.

The following samples were prepared for the test:

Size of the respective ceramic balls: Nominal diameter: 5/32 (3.969 mm in diameter)
Weight of the respective ceramic balls: 0.11 g
Material of the ceramic balls: Si₃N₄
Surface roughness values of the respective ceramic balls: Ra 0.002 to Ra 0.03 (as measured by Talysurf)
Material of the seating surfaces: SCR420
Shape of the seating surfaces: Annular surface having a chamfer with a radius of curvature of 1.2 formed along the edge of the opening of the oil passage

The test was conducted under the following conditions:

Vibrator: Hydraulic servo vibrator
Load applied: 1700 N (as measured by a load cell attached to the vibrator)
Number of vibrations applied: 5×10⁶
Vibration frequency: 300 Hz
Ambient temperature: 100° C. (by surrounding samples with a high-temperature tank)

Under the above conditions, loads were repeatedly applied to the rods 19 of the respective samples to determine to what degree the seating surface 16 of the check valve 13 of each sample became worn. Specifically, at four circumferentially spaced points on the area of each seating surface 16 which had been scraped off due to wear (the area which had been deformed to the same radius of curvature as the surface of the ceramic ball 15), the axial width was measured and their sum (hereinafter referred to “the sum of wear widths”) was calculated to evaluate the degree of wear of the respective seating surfaces 16.

As a result, as shown in FIG. 3, for the samples of which the surface roughness values of the respective ceramic balls 15 were Ra 0.002 and Ra 0.01, respectively, the sum of wear widths of each seating surface 16 was not more than 50 μm, which means that the seating surfaces 16 got scarcely worn. In contrast, for the samples of which the surface roughness values of the respective ceramic balls 15 were Ra 0.02 and Ra 0.03, respectively, the sum of wear widths of each seating surface 16 was markedly higher than for the samples of which the surface roughness value of the ceramic ball is not more than Ra 0.01.

These results show that by adjusting the surface roughness value of the ceramic ball 15 to not more than 0.01, the seating surface 16 of the check valve 13 is extremely less likely to become worn.

What is claimed is:

1. An auto-tensioner comprising a cylinder having a bottom at a lower end thereof, a sleeve having a bottom and fitted in the cylinder, wherein hydraulic oil is stored in the cylinder, a plunger slidably inserted in the sleeve, thereby partitioning the interior of the housing into a pressure chamber and a reservoir chamber, said pressure chamber communicating with said reservoir chamber through an oil passage, a check valve that permits only the flow of hydraulic oil from the reservoir chamber into the pressure chamber through the oil passage, a rod axially movable together with the plunger, and a return spring biasing the rod in a direction to increase the volume of the pressure chamber,
wherein said check valve comprises a seating surface formed at an end of said oil passage facing said pressure chamber, a ceramic ball configured to move into contact with and separate from the seating surface, thereby closing and opening the oil passage, and a retainer for restricting the moving range of said ceramic ball, said ceramic ball having a surface roughness Ra of not more than 0.01.

2. The auto-tensioner of claim 1 wherein said end of the oil passage facing the pressure chamber is open to a bottom surface of said plunger to define a bottom opening of the oil passage, and wherein said ceramic ball is configured to open and close said bottom opening of the oil passage.

3. The auto-tensioner of claim 1 wherein said ceramic ball is made of silicon nitride.

4. The auto-tensioner of claim 2 wherein said ceramic ball is made of silicon nitride.

5. The auto-tensioner of claim 1 wherein said seating surface is made of iron.

6. The auto-tensioner of claim 2 wherein said seating surface is made of iron.

7. The auto-tensioner of claim 3 wherein said seating surface is made of iron.

8. The auto-tensioner of claim 4 wherein said seating surface is made of iron.
